(19) United States
(12) Patent Application Publication
(10) Pub. No.: US 2012/0277900 A1
(43) Pub. Date: Nov. 1, 2012

(54) INJECTION MOLDING ASSEMBLY HAVING PROCESSING CIRCUIT

(75) Inventor: Bruce Catoen, Georgetown (CA)

(73) Assignee: Mold-Masters (2007) Limited, Georgetown (CA)

(21) Appl. No.: 13/098,039

(22) Filed: Apr. 29, 2011

(51) Int. Cl. B29C 45/72

(52) U.S. Cl. 700/202; 700/200

(57) ABSTRACT

There is set forth a system comprising an injection molding assembly mold and a processing circuit. The mold can have a stationary section and a moveable section. The stationary section can have a channel assembly and one or more nozzle. The processing circuit can comprise one or more processor, a communication interface, and a memory including a volatile memory and a non-volatile memory. The processing circuit can be mounted to the stationary section or the moveable section in a manner that the processing circuit can be supported in a fixed position relative to the stationary section or the moveable section. The mold can further comprise one or more sensor unit, each sensor unit including one or more sensor. The system can be configured to transmit via the communication interface at least a portion of data outputted by the one or more sensor unit responsive to a request from an external computer, a change in at least one sensor reading, expiration of a pre-defined timeout, or completion of a reading cycle of the one or more sensor unit.

### FIELD OF THE INVENTION

The present invention relates to injection molding assemblies in general and specifically to an injection molding assembly having a processing circuit.

### BACKGROUND OF THE PRIOR ART

Injection molding assemblies are known to include a variety of components including an injection molding machine and a mold. An injection molding machine can be capable of receiving injection molding material, heating the material, and forcing the injection molding material into the mold.

A mold can comprise a number of components. In one embodiment a mold can comprise a stationary section and a moveable section, a hot runner including a channel assembly having one or more channels, heating elements for heating the one or more channel and a system of nozzles, and a cavity releasably closable in relation to the stationary section. Where a mold comprises a hot runner, the stationary section is sometimes referred to as a hot half and a moveable section is sometimes referred to as a cold half. Hot runner systems are equipped with a temperature controller for regulating a temperature of injection molding material (a melt stream) through a hot runner. A temperature controller can include temperature sensors operatively disposed to sense a temperature of a hot runner. Other injection molding systems without hot runners have unheated channels through which injection molding material flows.

### SUMMARY OF THE INVENTION

In one embodiment, there is provided a system comprising an injection molding assembly mold and a processing circuit. The mold can have a stationary section and a moveable section. The stationary section can have a channel assembly and one or more nozzle. The processing circuit can comprise one or more processor and a communication interface. The processing circuit can be mounted to the stationary section or the moveable section in a manner that the processing circuit can be supported in a fixed position relative to the stationary section or the moveable section. The mold can further comprise one or more sensor unit, each sensor unit including one or more sensor. The system can be configured to transmit via the communication interface at least a portion of data outputted by the one or more sensor unit responsive to a request from an external computer, a change in at least one sensor reading, expiration of a pre-defined timeout, or completion of a reading cycle of the one or more sensor unit.

In another embodiment, there is provided a system comprising an injection molding assembly mold and a processing circuit. The mold can have a stationary section and a moveable section. The stationary section can have a channel assembly and one or more nozzle. The processing circuit can comprise one or more processor, a communication interface, and a memory including a volatile memory and a non-volatile memory. The processing circuit can be mounted to the stationary section or the moveable section in a manner that the processing circuit can be supported in a fixed position relative to the stationary section or the moveable section. The mold can further comprise one or more sensor unit, each sensor unit including one or more sensor. The system can be configured to perform storing in the non-volatile memory at least a first portion of data outputted by the one or more sensor unit, transmitting via the communication interface at least a second portion of data outputted by the one or more sensor unit, and purging from the non-volatile memory at least a third portion of data outputted by the one or more sensor unit, wherein the second portion of data includes the third portion of data.

In another embodiment, there is provided a system comprising an injection molding assembly mold and a processing circuit. The mold can have a stationary section and a moveable section. The stationary section can have a channel assembly and one or more nozzle. The processing circuit can comprise one or more processor, a communication interface, and a memory including a volatile memory and a non-volatile memory. The processing circuit can be mounted to the stationary section or the moveable section in a manner that the processing circuit can be supported in a fixed position relative to the stationary section or the moveable section. The mold can further comprise one or more sensor unit, each sensor unit including one or more sensor. The system can be configured to perform storing in the non-volatile memory at least a first portion of data outputted by the one or more sensor unit, transmitting via the communication interface at least a second portion of data outputted by the one or more sensor unit, and purging from the non-volatile memory at least a third portion of data outputted by the one or more sensor unit, wherein the first portion of data includes the third portion of data.

In another embodiment, there is provided a system comprising an injection molding assembly mold and a processing circuit. The mold can have a stationary section and a moveable section. The stationary section can have a channel assembly and one or more nozzle. The processing circuit can comprise one or more processor, a communication interface, and a memory including a volatile memory and a non-volatile memory. The processing circuit can be mounted to the stationary section or the moveable section in a manner that the processing circuit can be supported in a fixed position relative to the stationary section or the moveable section. The mold can further comprise one or more sensor unit, each sensor unit including one or more sensor. The system can be configured to perform storing in the non-volatile memory at least a portion of data outputted by the one or more sensor unit and/or transmitting via the communication interface at least a portion of data outputted by the one or more sensor unit, wherein the data outputted by the one or more sensor unit is digitally signed before storing and transmitting.

In another embodiment, there is provided a system comprising an injection molding assembly mold and a processing circuit. The mold can have a stationary section and a moveable section. The stationary section can have a channel assembly and one or more nozzle. The processing circuit can comprise one or more processor, a communication interface, and a memory including a volatile memory and a non-volatile memory. The processing circuit can be mounted to the stationary section or the moveable section in a manner that the processing circuit can be supported in a fixed position relative to the stationary section or the moveable section. The mold can further comprise one or more sensor unit, each sensor unit including one or more sensor. The system can be configured to store in the local database at least a portion of data outputted by the one or more sensor unit. The local database can be provided by at least one flat file, a relational database, or a hierarchical database.

### BRIEF DESCRIPTION OF THE DRAWINGS

Features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1a is a schematic diagram of an injection molding assembly;

FIG. 1b is a schematic diagram illustrating an injection molding assembly cycle;

FIG. 2 is a schematic diagram illustrating a hot runner nozzle equipped with temperature sensor units and heating elements;

FIGS. 3a-3b are schematic diagrams illustrating a processing circuit housing mounted to the mold stationary section;

FIG. 4a illustrates a mold processing circuit mounted to the mold stationary section or moving section;

FIG. 4b illustrates a schematic diagram of a system comprising an injection molding assembly mold and a processing circuit;

FIG. 5 is a schematic diagram of one embodiment of a software architecture for the mold processing circuit;

FIG. 6 is a schematic diagram of one embodiment of locally storing and transmitting via communication interface of data determined utilizing one or more signals output by one or more sensor unit;

FIG. 7 is a schematic diagram of another embodiment of locally storing and transmitting via communication interface of data determined utilizing one or more signals output by one or more sensor unit;

FIG. 8 is a flow diagram illustrating one embodiment of a method that can be performed by the mold processing circuit.

### DETAILED DESCRIPTION OF THE INVENTION

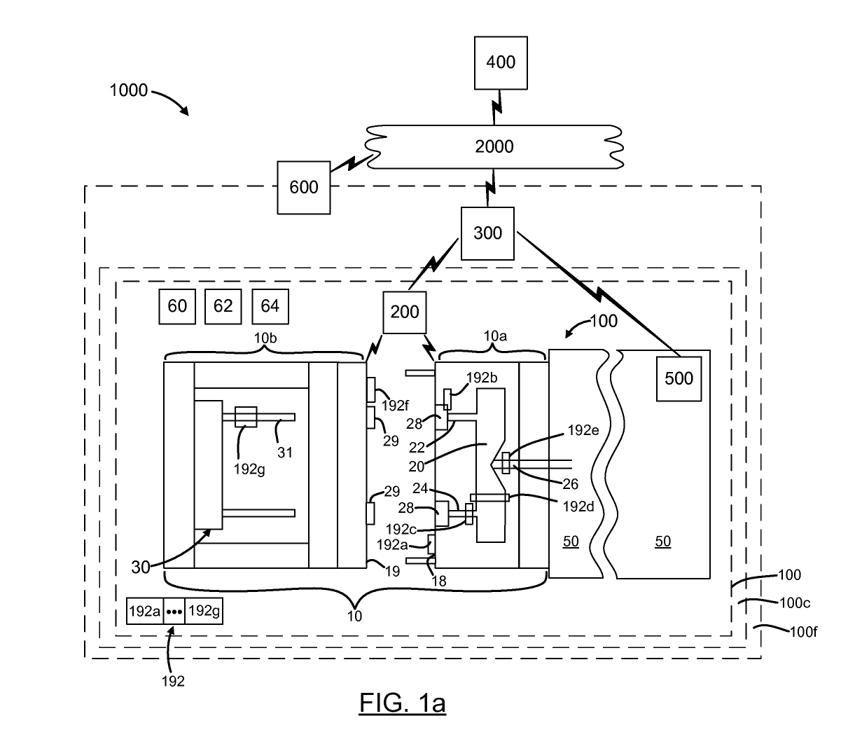

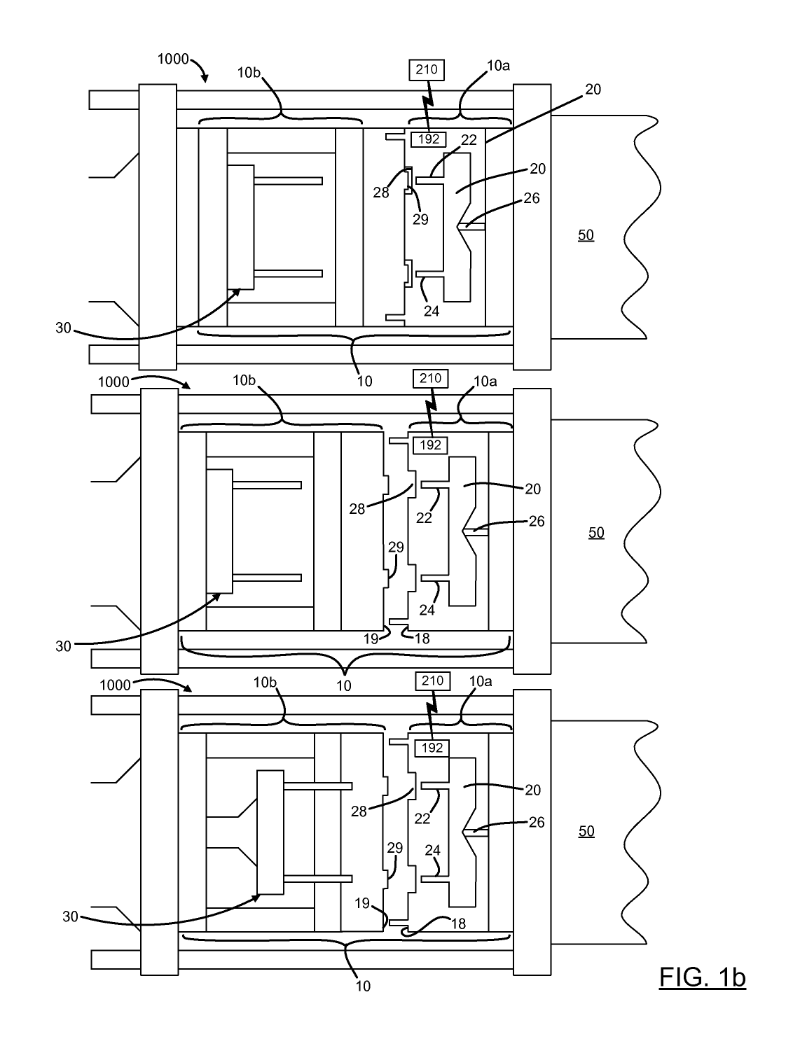

There is set forth herein a system 1000 having an injection molding assembly mold 10 including a stationary section 10a and moveable section 10b, as depicted in FIG. 1a. Stationary section 10a can include a sprue 26, channel assembly 20 (manifold) one or more nozzle 22, 24. In one embodiment, mold 10 can include a mold cavity 28 and a mold core 29. Mold cavity 28 can be defined by stationary section 10a. Mold core 29 can be defined by moveable section 10b. The facing surfaces 18 and 19 of mold sections 10a and 10b define a parting line as would be understood by one of ordinary skill in the art.

The injection molding assembly 100 can have a mold 10, an injection molding machine 50 including an associated injection molding machine processing circuit 500, and a plurality of auxiliary mold assembly components, e.g., a dryer 60, a chiller 62, and a robot 64. The injection molding machine 50 can be used for forcing injection molding material into mold 10.

Operation of an injection molding assembly cycle can be understood with reference to FIG. 1b. With mold 10 in a clamped state (first view) injection molding material can be forced by injection molding machine 50 through sprue 26 channel assembly 20 and one or more nozzle 22, 24 into cavity 28 of stationary section 10a, sometimes referred to as an injection half or “hot half.” After injection of molding material is complete for a certain cycle, moveable mold section 10b can be de-clamped and separated from stationary mold section 10a (second view). With mold section 10b separated from mold section 10a, ejector assembly 30 can be activated (third view) to eject molded parts from mold section 10b which prior to ejection can be held in place by a mold core 29. After ejection of a finished part, moveable mold section 10b can be re-clamped to the clamped state as shown in FIG. 1b (first view).

Referring again to FIG. 1a, the system 1000 can further comprise one or more processing circuit, the one or more processing circuit including, in one embodiment, a mold processing circuit 200. In a further aspect, the mold processing circuit 200 can be mounted to the stationary section or the moveable section in a manner that the processing circuit 200 can be supported in a fixed position relative to the stationary section or the moveable section as described in details herein infra.

In another aspect, the system 1000 can further have one or more sensor unit 192. A sensor unit can comprise one or more sensor. As will be described further herein, system 1000 can utilize an output of the one or more sensor unit for determining a condition prevailing with an injection molding assembly, e.g., a cycle count of one or more component of the mold 10.

The system 1000 can comprise one or more sensor unit for determining a cycle count of one or more component of the mold 10. In the illustrative embodiment of FIG. 1a, the system 1000 can comprise sensor units 192a-192g.

A sensor unit can be of one or more sensor type, e.g., a proximity sensor, a force sensor, a pressure sensor, a contact sensor, a temperature sensor, an optical sensor, an ultrasonic sensor, and an accelerometer. In one embodiment, the system 1000 can include one or more clamping state sensor unit configured to sense contact with moveable section 10b and accordingly can output a signal indicating a clamped/declamped state of the mold 10. In one embodiment, the system 1000 can include one or more sensor unit for sensing whether there is a flow of fluid (in the form of a melt stream) through mold section 10a. A sensor unit for sensing whether there is a flow of fluid through mold section 10a can be provided by a plurality of different types of sensor units, including, e.g., a force sensor, a pressure sensor, a temperature sensor, an accelerometer, and a flow meter sensor (such as an ultrasonic flow meter disposed across a melt stream and deployed as nozzle sensor, channel assembly sensor, or inlet sensor).

In one embodiment, a sensor can be configured to output a binary digital signal representative of the value being measured. In another embodiment, a sensor can be configured to output an analog signal representative of the value being measured. In a further aspect, the analog signal outputted by a sensor can have a variable amplitude and/or variable frequency.

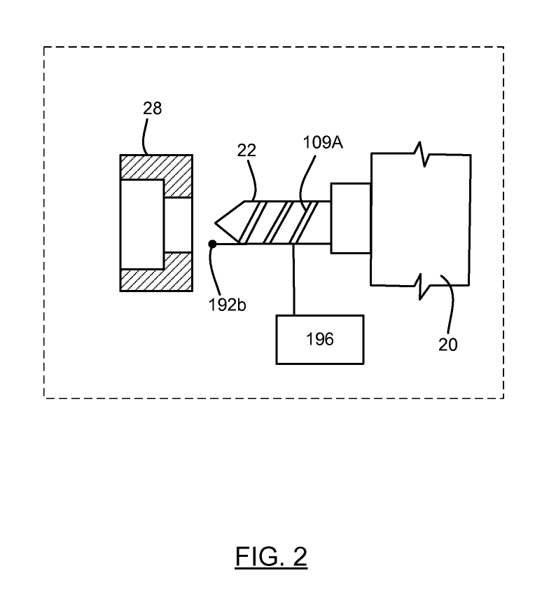

Referring to FIG. 2, the mold stationary section 10a (sometimes referred to as a hot half) can include at least one hot runner nozzle 22 coupled to channel assembly (manifold) 20. In operation, the channel assembly 20 can receive a melt stream of a moldable material from a source (not shown) and deliver the melt stream through the nozzle 22 to a mold cavity 28 provided between the mold stationary section 10a and mold moveable section 10b of FIG. 1a.

In another aspect, at least one temperature sensor 192b can be coupled to the nozzle 22 in order to provide temperature measurements thereof. In another aspect, the nozzle 22 can be heated by at least one heating element 109a-109f. The locations of temperature sensors and heating elements within the hot runner system can be referred to as heating zones.

In one embodiment, system 1000 can further comprise one or more power switching module 196. In another aspect, each power switching module can be coupled to a controlled device installed on the mold. In one embodiment, one or more power switching module 196 can be coupled to one or more heating element 109.

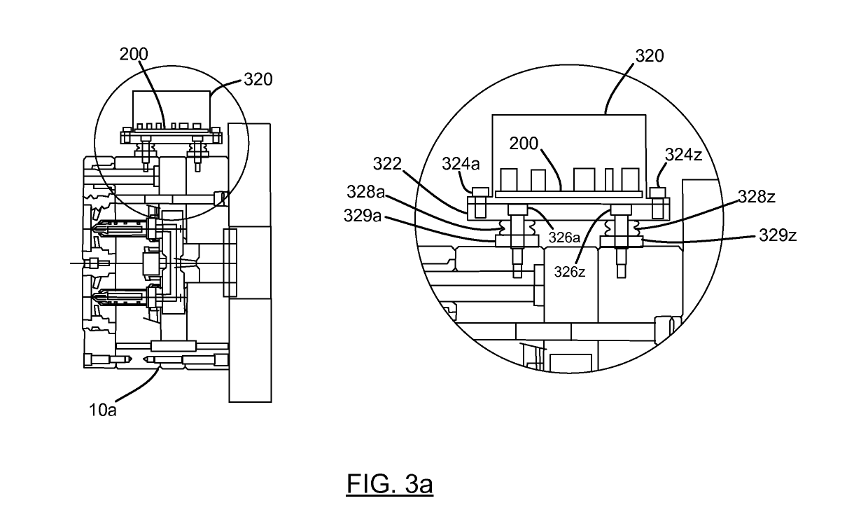

In one embodiment, the mold processing circuit 200 can be disposed within a housing. The housing 320 can be mounted to the mounting plate 322 by one or more housing mounting bolt 324a-324z, as best viewed in FIG. 3a. The mounting plate 322 can in turn be mounted to the mold stationary section (hot half) 10a by one or more mounting bolt 326a-326z equipped with vibration absorbing bushings 328a-328z which in one embodiment can be made of polyurethane or a similar synthetic material. The mounting bolts 326a-326z can be further equipped with mounting spacers 329a-329z. In one embodiment, schematically shown in FIG. 3b, an insulating plate 331 can be provided between the mounting spacers 329a-329z and the surface of the mold stationary section (hot half) 10a.

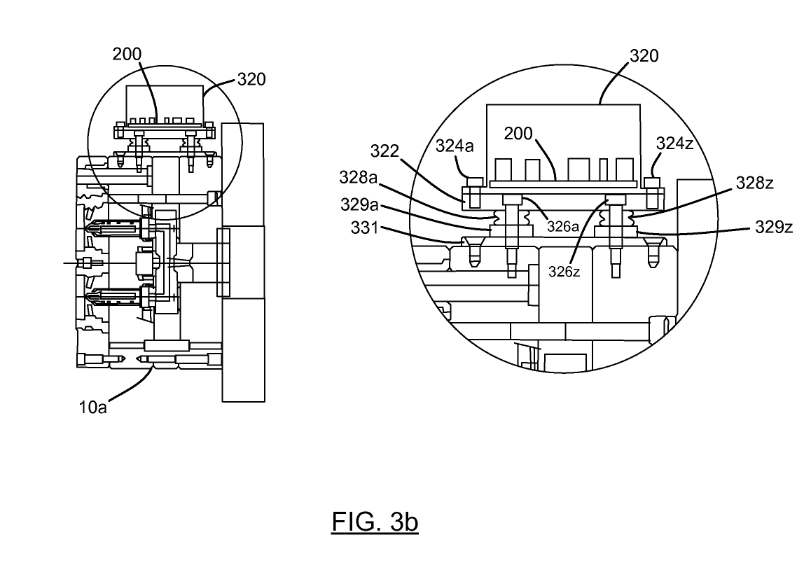

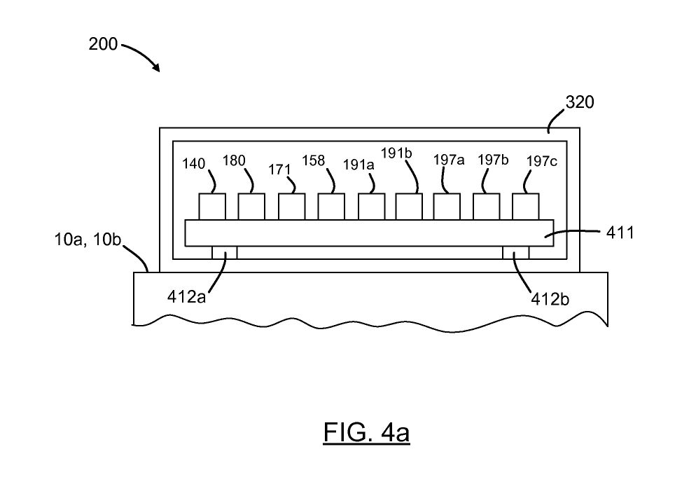

In one embodiment, processing circuit 200 can be mounted to the stationary section 10a or the moveable section 10b in a manner that the processing circuit 200 can be supported in a fixed position relative to the stationary section 10a or the moveable section 10b. Referring to FIG. 4a, components of the processing circuit, including one or more processor 140, a communication interface 180, a display interface 171, one or more I/O interfaces 191a . . . 191g for coupling one or more sensor unit (not shown in FIG. 4a), one or more switching module interface 197a . . . 197f, and memory 158, can be disposed on one or more printed circuit board (PCB) 411 using pluggable (e.g., connectors) or permanent (e.g., bolts) mounts (not shown in FIG. 4a). One or more PCB can be fixedly mounted to housing 320, e.g., using one or more mounting bolt 412a-412f. As described herein supra with reference to FIGS. 3a and 3b, the housing 320 can be mounted to a mounting plate by one or more housing mounting bolt which can in turn be mounted to the mold stationary section or moveable section by one or more mounting bolt (not shown in FIG. 4a).

A skilled artisan would appreciate that other methods of supporting the mold processing circuit 200 in a fixed position relative to the mold stationary section or mold moveable section are within the scope of this disclosure. In FIGS. 3a-3b, mold processing circuit 200 and housing 320 are shown coupled to the mold stationary section 10a by way of example and not limitation. In one embodiment mold processing circuit 200 and housing 320 can be coupled to the mold moveable section 10b.

An exemplary block electrical diagram of system 1000 is shown and described in FIG. 4b. System can comprise an injection molding assembly mold 10 and a processing circuit 200. The processing circuit 200 can comprise one or more processor 140. One or more processor 140 can be provided by a general purpose microprocessor or by a specialized microprocessor (e.g., an application-specific integrated circuit (ASIC)). In one embodiment, the mold processing circuit 200 can comprise a single processor which can be referred to as a central processing unit (CPU). In another embodiment, the mold processing circuit 200 can comprise two or more processors, for example a CPU and a specialized microprocessor (e.g., an ASIC).

The mold processing circuit 200 can further comprise a memory 158 which can include one or more of a system volatile memory 152 (e.g., RAM), system non-volatile memory 154 (e.g., ROM or flash memory), and a storage device 156. Storage device 156 can be provided e.g., by a flash memory device, a hard drive, a floppy disk, or a compact disk. Devices forming memory 158 can be regarded as devices that form a tangible computer readable storage medium. CPU 140 and memory 158 can be in communication via system bus 145. Memory 158 can be configured to store one or more program for execution by CPU 140.

Mold processing circuit 200 can further include a communication interface 180 allowing network communications with external computers. In one embodiment, communication interface 180 can be provided by a wireless network interface, e.g., an IEEE 802.11-compliant interface or a Bluetooth interface. In another embodiment, communication interface 180 can be provided by an Ethernet network interface. In a yet another embodiment, communication interface 180 can be provided by a serial interface, e.g., RS/232, RS/485 or USB-compliant port. A skilled artisan would appreciate that other types of communication interfaces are within the scope of this disclosure.

Mold processing circuit 200 can further include a display interface 171 which allows connecting a video-monitor, e.g., an SVGA monitor. Mold processing circuit 200 can further include a user input interface which allows connecting a pointing device and/or a keyboard. A skilled artisan would appreciate that other UI interfaces are within the scope of this disclosure.

Mold processing circuit 200 can further include one or more I/O interfaces 191a-191g for coupling one or more sensor unit 192a-192g. In one embodiment, interfaces 191a-191g can include a plurality of registers in combination with appropriate circuitry for writing to the registers digitized sensor unit signals, the sensor unit signals generated by the various sensor units 192. In one embodiment, interfaces 191a-191g can include one or more analog-to-digital (A/D) converters to convert analog outputs of the various sensor units 192 into a digital form suitable for writing into one or more registers communicatively coupled to the system bus 145. In one embodiment, interfaces 191a-191g can further comprise one or more amplifiers and/or other signal conditioning devices not shown).

In one embodiment, mold processing circuit 200 can further comprise one or more multiplexers 193 configured to select a sensor unit to be connected to a sensor interface 191 or to a signal conditioning device. In a further aspect, a multiplexer 193 can be controlled by the processor 140 via system bus 145 to perform time division multiplexing of input signals. Employing time division multiplexing allows using a single signal conditioning device (e.g., an amplifier) and a single sensor interface 191 for inputting of several sensor unit signals (e.g., temperature signals from several heating zones).

In one embodiment, mold processing circuit 200 can further comprise one or more switching module interface 197a . . . 197f configured to couple one or more switching module to the system bus 145. In one embodiment, switching module interface can be provided by a digital-to-analog (D/A) converter coupled to the system bus 145 via an I/O port. In one embodiment, two or more power switching modules can be multiplexed to a single switching module interface using an analog signal multiplexer. In one embodiment, the analog signal multiplexer can be controlled by the processor 140 via system bus 145. A skilled artisan would appreciate that other embodiments of switching module interfaces are within the scope of this disclosure.

In another aspect, mold processing circuit 200 can be configured to execute a heating control software program to control the current and/or power supplied to one or more heating element 109a . . . 109f through control signals outputted to one or more power switching module 196a . . . 196f via one or more switching module interface 197a . . . 197f. One or more power switching module 196a . . . 196f, responsive to receiving a control signal via one or more switching module interface 197a . . . 197f can switch the high voltage supply to one or more heating element 109a . . . 109f.

In one embodiment, the heating control software program can be executed by one or more processors 140 of the mold processing circuit 200. In another embodiment, two or more instances of the heating control software program can be executed independently by two or more processors. In a further aspect, a single instance of the heating control software program can be configured to control one or more heating zone.

In one embodiment, a processor executing one or more instances of the heating control software program can be disposed on a dedicated PCB controller card. Also disposed on the PCB controller card can be other components of the processing circuit, including memory, one or more temperature sensor interface, one or more power switching module interface, and one or more communication interfaces. A single PCB controller card can be configured to control one or more heating zones. In one embodiment, a single PCB controller card can be configured to control two heating zones.

In one embodiment, one or more controllers 141a-141z executing one or more instances of the heating control software program can be disposed externally to the mold, and can be in communication with the mold processing circuit 200 via the communication interface 180.

In another aspect, a processor executing the heating control software program can be configured to read the temperature measured by one or more temperature sensor units and adjust the heating of one or more heating zone by adjusting the level of the current and/or power supplied to one or more heating element through control signals outputted to one or more power switching module via one or more switching module interface.

In one embodiment, the processor executing the heating control software program can be configured to determine whether the measured temperature in a heating zone is within a pre-defined temperature range and make a corresponding adjustment to the power and/or current supplied to one or more heating element for the heating zone.

In one embodiment, the processor executing the heating control software program can be configured to implement a control algorithm configured to minimize the difference between the measured process variable (e.g., temperature) and a desired setpoint (e.g., a median value of a pre-defined temperature range for a particular heating zone) by adjusting the process control variable (e.g., a power or a current supplied to the zone heating element).

In one embodiment, the processor executing the heating control software program can be configured to implement a proportional-integral-derivative (PID) control algorithm. According to the PID algorithm, the difference between the measured process variable and the desired setpoint can be calculated as a weighted sum of a Proportional (i.e., the measured process variable multiplied by a weight coefficient), an Integral (i.e., an integral of the process variable on a given time interval), and a Derivative (i.e. a derivative of the process variable in a given point). In another embodiment, the processor executing the heating control software program can be configured to implement a proportional-integral-second derivative (PID²) control algorithm. A skilled artisan would appreciate that other control algorithms are within the scope of this disclosure.

In a further aspect, the processor executing the heating control software program can be configured to re-calculate one or more adjustment values of one or more process control variable (e.g., a power or a current supplied to the zone heating element) with a pre-defined frequency. In another aspect, the control frequency can be adjusted based on the value of the first or second derivative of the measured process variable (e.g., heating zone temperature). A skilled artisan would appreciate that other methods of adjusting the control frequency are within the scope of this disclosure.

In another aspect, the processor executing the heating control software program can be configured to trigger an alarm responsive to determining that the value of one or more measured process variable exceeded a pre-defined alarm threshold.

Referring to further aspects of system 1000, injection molding assembly 100 can be in network communication with facility server 300 disposed within the manufacturing facility where injection molding assembly 100 is located, but externally relative to the work cell comprising injection molding assembly 100, as depicted in FIG. 1a. Server 300 can be in communication with server 400 via network 2000. Server 400 can be disposed at a location remote from the manufacturing facility where injection molding assembly 100 is located. System 1000 can further include a client computer 600 provided by, e.g., a desktop PC, a laptop PC, or by a smart phone, e.g., BLACKBERRY STORM by Research and Motion of Waterloo, Ontario. In one embodiment, the client computer 600 can be connected to the network 2000. System 1000 can further include one or more controllers 141a-141z configured to execute one or more instances of the heating control software program. In one embodiment, one or more controllers 141a-141z can be connected to the network 2000. In one embodiment, one or more controllers 141a-141z can communicate with the mold processing circuit 200 directly through the communication interface 180. A skilled artisan would appreciate that the network topology shown in FIG. 1a depicts an illustrative embodiment, and other network topologies including wired and wireless networks are within the scope of this disclosure.

By virtue of their including at least a CPU, a memory, and a communication interface, each of mold processing circuit 200, server 400, client computer 600, and one or more controllers 141a-141z can be regarded as “computer” herein. Each computer of system 1000, e.g., 200, 300, 400, 500, 600, 141 can be configured in accordance with the TCP/IP suite of protocols so that each computer of system 1000 is in IP network communication with each other computer of system 1000.

In one embodiment, system 1000 can be configured to store in memory 158 (e.g., in non-volatile memory 154 or on storage device 156) of mold processing circuit 200 one or more signals output by sensor units 192. In another embodiment, system 1000 can be further configured to store in memory 158 timestamps and/or record identifiers associated with one or more signals output by sensor units 192. In a yet another embodiment, system 1000 can be configured to store in memory 158 data determined utilizing one or more signals output by sensor units 192. Such data can, e.g., represent cycle counts of one or more component of the mold 10, including wet cycle counts, dry cycle counts, and/or total cycle counts. A skilled artisan would appreciate that other types of data determined utilizing one or more signals output by sensor units 192, including raw sensor unit outputs, are within the scope of this disclosure.

In a further aspect, mold processing circuit 200 can store in local memory 158 (e.g., in non-volatile memory 154 or on storage device 156) time stamped and/or identifier stamped raw signal and cycle count outputs of sensor units 192a-192g for an entire history of mold, thus demonstrating at least one advantage of having an on-mold processing circuit: by storing a record of the life cycle of the mold in on-mold processing circuit, it can be virtually guaranteed that the mold's life cycle record would be always available and up-to-date.

In another aspect, system 1000 can be configured to transmit at least a portion of data determined utilizing one or more signals output by sensor units 192 via the communication interface 180 to one or more computers in communication with system 1000 (e.g., to one or more computers 300, 400, 500 and 600). As noted herein supra, the data items transmitted by system 1000 via the communication interface 180 can include raw sensor outputs, data derived from sensor unit outputs by a program executed by CPU 140, and other data items (e.g., identifiers and/or timestamps) associated with the raw sensor outputs and data derived from sensor outputs.

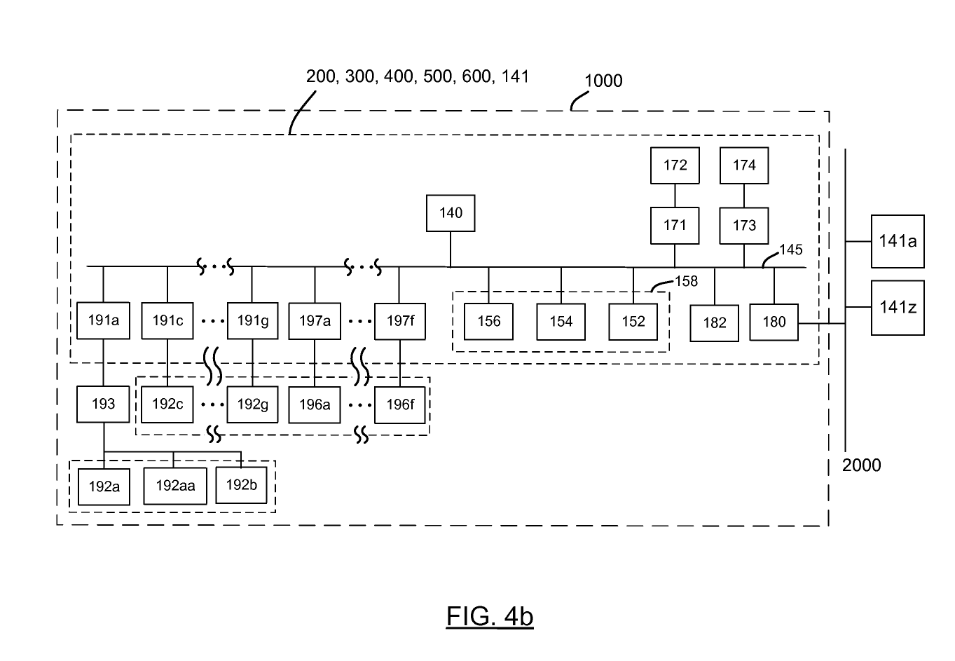

In one embodiment, system 1000 can be configured to transmit at least a portion of data determined utilizing one or more signals output by sensor units 192 via the communication interface 180 responsive to request from an external computer. In one embodiment, schematically illustrated in FIG. 5, the mold processing circuit can be configured to run an HTTP server process 410 (e.g., httpd process in a Unix-family operating system). The HTTP server process 410 can be configured to receive via the communication interface 180 an HTTP request 420 initiated by an external computer 900. The HTTP server process 410 can be further configured to forward the request 420 it to an application server process 430 (e.g., a Java-based process) for processing. The application server process 430 can parse the request 420 and build a response 422. In one embodiment the application server process 430 can build the response 422 by querying a local database 440 which is described more in details herein infra. In one embodiment the application server process 430 can build the response 422 by querying the sensor interfaces 191a-191g.

Upon successfully building the response 422, the application server process 430 can forward the response 422 to the HTTP server process 410, which can wrap the response 422 into an HTTP response envelope, and transmit the HTTP response 424 back to the requesting computer 900.

In another embodiment, the mold processing circuit can be configured to run an FTP server software process (e.g., ftpd process in a Unix-family operating system) which can be configured to receive an FTP request and transmit back to the requesting computer the requested file or directory information. A skilled artisan would appreciate that other suitable request-response based protocols and underlying software architectures are within the scope of this disclosure.

In another aspect, system 1000 can be configured to transmit at least a portion of data determined utilizing one or more signals output by sensor units 192 via the communication interface 180 in a push mode (i.e., without receiving requests from an external computer). In one embodiment, a push mode transmission can be performed with a pre-defined frequency (i.e., upon expiration of a pre-defined timeout measured from the previous transmission time). In another embodiment, a push mode transmission can be performed responsive to detecting a change in at least one sensor reading as compared to the previous transmission. In a yet another embodiment, a push mode transmission can be performed responsive to completing a reading cycle of one or more sensor. In a yet another embodiment, a push mode transmission can be performed responsive to detecting a pre-defined state of the system 1000 (e.g., upon completing a production cycle). In a yet another embodiment, a push mode transmission can be performed responsive to establishing an up-link with an external computer. A skilled artisan would appreciate that other push mode transmission schemes are within the scope of this disclosure.

In another aspect, the communication interface 180 can be provided by an RS/232 or RS/485-compliant serial interface, which can be electrically coupled by a cable to a “dumb” terminal. The term “dumb” terminal as used herein shall refer to a communication device having a screen and, possibly, a keyboard, which is not capable of executing any program or performing any data processing.

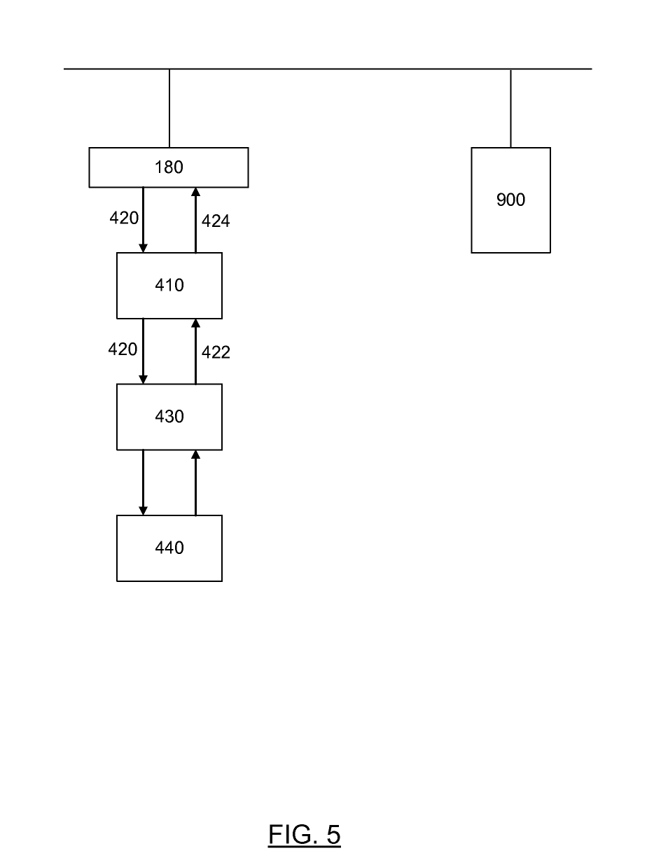

In another aspect, memory 158 can be limited in size, and hence in one embodiment, at least a portion of data determined utilizing one or more signals output by sensor units 192 can be intended for a remote storage only. In one embodiment, the system 1000 can be configured to transmit via the communication interface 180 raw sensor outputs of sensor units 192 for every measurement cycle, while storing locally raw sensor outputs of sensor units 192 for every N^{th} measurement cycle, wherein N is a positive integer. In another embodiment, the system 1000 can be configured to transmit via the communication interface 180 raw sensor outputs of all sensor units 192, while storing locally raw sensor outputs of selected sensor units 192. In a yet another embodiment, schematically illustrated in FIG. 6, for every data set 510a-510z of data determined utilizing one or more signals output by sensor units (each of the data sets 510a-510z can represent, e.g., a full set of raw sensor outputs of sensors for one sensor reading cycle), the system 1000 can be configured to transmit via the communication interface at least a first portion 520a-520z of data, the first portion 520a-520z being a subset of the full data set 510a-510z. The system 1000 can be further configured to store in local memory 158 (e.g., in non-volatile memory 154 or on storage device 156)) at least a second portion 530a-530z of data, the second portion 530a-530z being a subset of the first portion 520a-520z. Thus, only a portion of the data set determined utilizing one or more signals output by sensor units can be stored in local memory, while the whole data set or at least a portion of it can be transmitted to a remote computer.

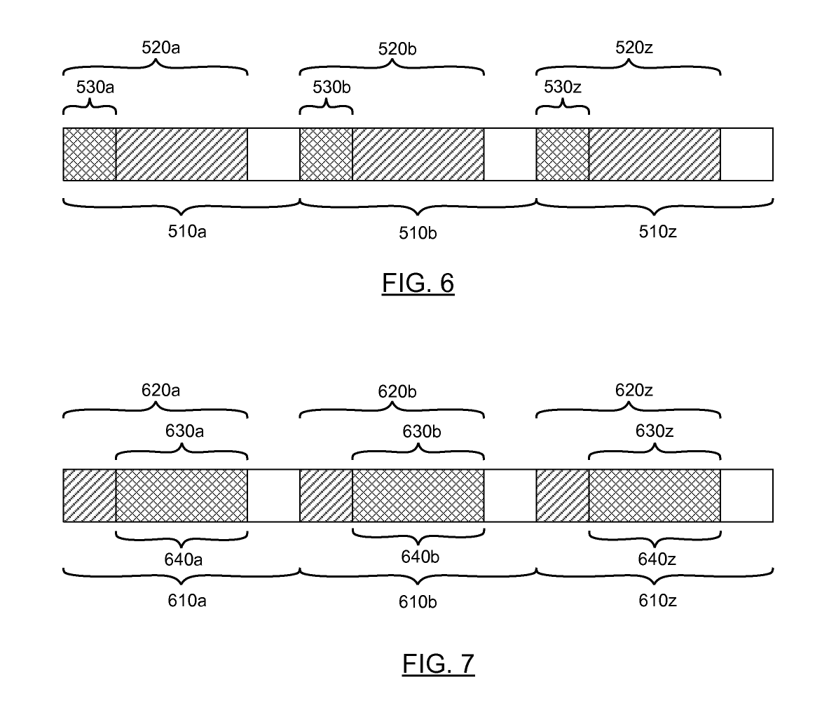

In another embodiment, the system 1000 can be configured to store a portion of data before transmitting at least of subset of the stored data to an external computer, in order not to lose any data should an attempted transmission to an external computer be unsuccessful. Then, in order to manage the amount of data stored in local memory 158, the system 1000 can be configured to purge from the local memory 158 at least a portion of the data successfully transmitted to an external computer. In the embodiment schematically illustrated in FIG. 7, for every data set 610a-610z of data determined utilizing one or more signals output by sensor units (each of the data sets 610a-610z can represent, e.g., a full set of raw sensor outputs of sensor units for one sensor reading cycle), the system 1000 can be configured to store in local memory 158 at least a first portion 620a-620z of data, the first portion 620a-620z being a subset of the full data set 610a-610z. The system 1000 can be further configured to transmit via the communication interface at least a second portion 630a-630z of data, the second portion 630a-630z being a subset of the first portion 620a-620z. Then, in order to manage the amount of data stored in local memory 158, the system 1000 can be configured to purge from the local memory 158 at least a third portion 640a-640z of data, the third portion 640a-640z being a subset of the first portion 620a-620z.

In a further aspect, transmitting the data via the communication interface 180 to an external computer can be performed independently and asynchronously of the storing in local memory 158: while it can be necessary to queue the data intended for transmission to a remote computer, storing data in a local memory 158 can be performed much faster, hence in one embodiment the two operations can be performed by independent software processes or threads. Referring back to FIG. 7, a first software process or thread can store the data sets 620a-620z upon completing building each data set (e.g., upon completing a reading cycle of the sensor units), while a second software process or thread can perform transmitting to an external computer of data portions 630a-630z.

In another aspect, system 1000 can be configured to digitally sign data determined utilizing one or more signals output by sensor units 192 before transmitting the data via the communication interface 180 to an external computer. In one embodiment, before initiating data transmission to an external computer, the system 1000 can request from the external computer its public key, and then encrypt the data to be transmitted to the external computer using the received public key. The external computer would use its private key to decrypt the data received from the system 1000, thus preventing a third party eventually intercepting the network transmission from getting the actual data. In another embodiment, the system 100 can encrypt the data to be transmitted to the external computer using the private key of system 1000, and the external computer receiving the data would use the public key of system 1000 to decrypt the received data. A skilled artisan would appreciate that other methods of digitally signing data determined utilizing one or more signals output by sensor units 192 before transmitting the data via the communication interface 180 to an external computer are within the scope of this disclosure.

In another aspect, system 1000 can be configured to digitally sign data determined utilizing one or more signals output by sensor units 192 before storing the data in local memory 158. In one embodiment, system 1000 can decrypt the data using its private key before storing the data, thus preventing a third party eventually obtaining a physical access to system 1000 from modifying the data stored in local memory 158. A skilled artisan would appreciate that other methods of digitally signing data determined utilizing one or more signals output by sensor units 192 before storing the data in local memory 158 are within the scope of this disclosure.

In another aspect, system 1000 can include a local database which can reside in local memory 158 for storing data determined utilizing one or more signals output by sensor units 192. In one embodiment, the local database can be provided by a relational database (e.g., mySQL, Microsoft SQL Server, Oracle, or DB/2). The relational database can be capable of processing SQL requests received from an external computer via communication interface 180 and further capable of transmitting the requested data back to the requesting computer. In another embodiment, the local database can be provided by a flat file having a fixed-size or variable-size records. In a yet another embodiment, the local database can be provided by a hierarchical database. A skilled artisan would appreciate that other database architectures suitable for locally storing data determined utilizing one or more signals output by sensor units 192 are within the scope of this disclosure.

In another aspect, system 1000 can be configured to be in communication with an operator interface via the communication interface 180. In one embodiment, the operator interface can be provided by a text-only serial dumb terminal (RS/232 or RS/485-compliant). In another embodiment, the operator interface can be provided by a graphical user interface (GUI)-capable device, e.g., a personal computer. A skilled artisan would appreciate that other suitable implementations of operator interface are within the scope of this disclosure.

In another aspect, mold processing circuit 200 can be utilized for control of a mold 10. System 1000 can be configured to perform a method whereby a certain control process can be activated responsively to evaluating an item of data determined utilizing one or more signals output by sensor units 192.

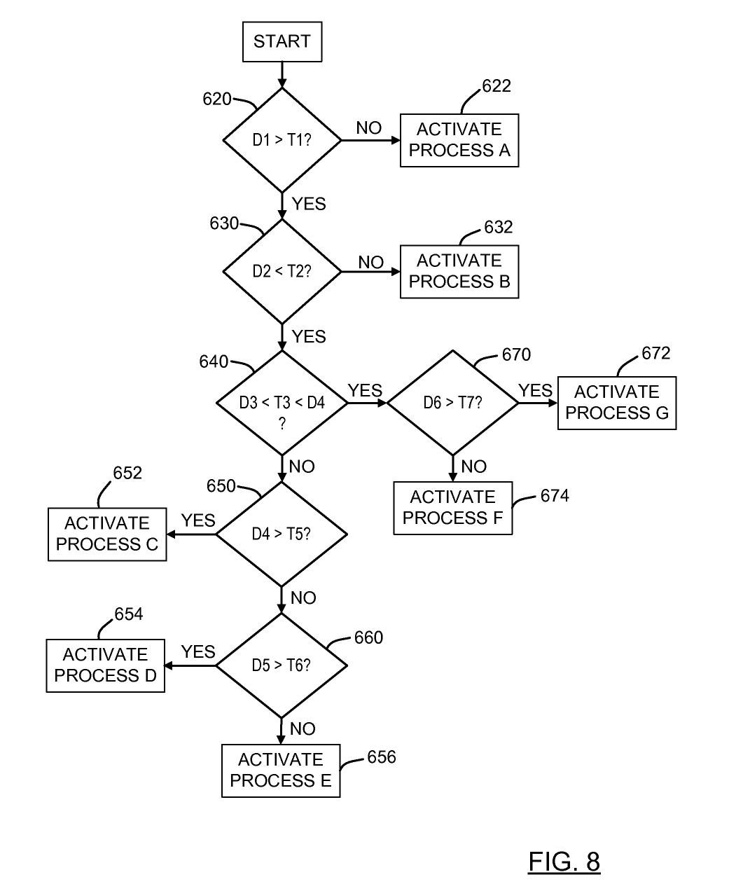

Referring to the flow diagram of FIG. 8, differentiated processes can be activated depending on values of items of data determined utilizing one or more signals output by sensor units 192. At Block 622 process A can be activated. At block 632, process B can be activated. At block 652, process C can be activated. At block 654, process D can be activated. At block 656, process E can be activated. At block 672, process G can be activated. At block 674, process F can be activated. The particular process that can be activated can be responsive to evaluating an item of data determined utilizing one or more signals output by sensor units 192. At block 620, system 1000 can determine whether the value of a first item data determined utilizing one or more signals output by sensor units 192 is greater than a threshold. At block 630, system 1000 can determine whether the value of a second item data determined utilizing one or more signals output by sensor units 192 is less than a threshold. At block 640, system 1000 can determine whether the value of a third item data determined utilizing one or more signals output by sensor units 192 is within a threshold range. At block 650, system 1000 can determine whether the value of a fourth item data determined utilizing one or more signals output by sensor units 192 is greater than a threshold. At block 660, system 1000 can determine whether the value of a fifth item data determined utilizing one or more signals output by sensor units 192 is greater than a threshold. At block 670, system 1000 can determine whether the value of a sixth item data determined utilizing one or more signals output by sensor units 192 is greater than a threshold.

Where processing circuit 200 includes a CPU 140 or other processor capable of executing computer program instructions, computer program instructions can be provided that are executable by the processor for performance of the methods described herein. Such computer program instructions can be stored on a computer readable medium. A computer readable medium can be provided, e.g., by one or more memory device of a memory, e.g., memory 158 associated to a processor, e.g., CPU processor 140 for executing the instruction. A computer readable medium can comprise memory devices of first and second externally disposed computers, e.g., first and second ones of computers 200, 300, 400, 500, 600. A computer readable medium can comprise a computer readable medium external to a processor for executing the instructions, e.g., a memory of an external server having a file system that stores program files for deployment to one or more computer of system 1000. There is set forth herein a computer readable storage medium readable by a processor and storing instructions for execution by the processor of the methods described herein. In an alternative embodiment, the methods described herein can be executed by more than one processor in accordance with a distributive processing method. The more than one processor can comprise processors of different computers e.g., CPUs of different ones of computers 200, 300, 400, 500, 600, and/or the more than one processor can comprise processors of a common computer, e.g., CPU 140 and a processor of an interface microcontroller of the common computer.

A small sample of systems methods and apparatus that are described herein is as follows:
A1. A system comprising:

a injection molding assembly mold having a stationary section and a moveable section, said stationary section having a channel assembly and one or more nozzle, said mold further comprising one or more sensor unit, each sensor unit including one or more sensor;

a processing circuit comprising one or more processor and a communication interface;

wherein said processing circuit is mounted to one of: said stationary section and said moveable section in a manner that said processing circuit is supported in a fixed position relative to one of: said stationary section and said moveable section;

wherein said system is configured to transmit via said communication interface at least a portion of data outputted by said one or more sensor unit responsive to one of: a request from an external computer, a change in at least one sensor reading, expiration of a pre-defined timeout, and completion of a reading cycle of said one or more sensor unit.
A2. The system of A1, wherein said processing circuit comprises at least one processor configured to execute a heating control software program to control at least one of: a power supplied to one or more heating element, a current supplied to one or more heating element.
A3. The system of A1, wherein said processing circuit comprises one or more sensor interface configured to input one or more sensor signals.
A4. The system of A1, wherein said processing circuit comprises one or more power switching module interface configured to be coupled to one or more switching module; and

wherein said one or more switching module is configured to control a controlled device.
A5. The system of A1, wherein said processing circuit is configured to communicate with at least one controller via said communication interface; and

wherein said at least one controller is configured to execute a heating control software program to control at least one of: a power supplied to one or more heating element, a current supplied to one or more heating element.
A6. The system of A1, wherein said communication interface is provided by at least one of: a wired interface, a wireless interface.
A7. The system of A1, wherein said communication interface is configured to be electrically coupled to a dumb terminal via a cable
A8. The system of A1, wherein said at least a portion of data outputted by said one or more sensor unit is digitally signed before said transmitting.
A9. The system of A1, wherein said processing circuit further comprises a memory including a volatile memory and a non-volatile memory;

wherein said system is further configured to store in said non-volatile memory at least a second portion of data outputted by said one or more sensor unit.
B1. A system comprising:

a injection molding assembly mold having a stationary section and a moveable section, said stationary section having a channel assembly and one or more nozzle, said mold further comprising one or more sensor unit, each sensor unit including one or more sensor;

a processing circuit comprising one or more processor, a communication interface, and a memory including a volatile memory and a non-volatile memory;

wherein said processing circuit is mounted to one of: said stationary section and said moveable section in a manner that said processing circuit is supported in a fixed position relative to one of: said stationary section and said moveable section;

wherein said system is configured to perform storing in said non-volatile memory at least a first portion of data outputted by said one or more sensor unit and transmitting via said communication interface at least a second portion of data outputted by said one or more sensor unit; and

wherein said second portion of data includes said first portion of data.
B2. The system of B1, wherein said processing circuit comprises at least one processor configured to execute a heating control software program to control at least one of: a power supplied to one or more heating element, a current supplied to one or more heating element.
B3. The system of B1, wherein said processing circuit comprises one or more sensor interface configured to input one or more sensor signals.
B4. The system of B1, wherein said processing circuit comprises one or more power switching module interface configured to be coupled to one or more switching module; and

wherein said one or more switching module is configured to control a controlled device.
B5. The system of B1, wherein said processing circuit is configured to communicate with at least one controller via said communication interface; and

wherein said at least one controller is configured to execute a heating control software program to control at least one of: a power supplied to one or more heating element, a current supplied to one or more heating element.
B6. The system of B1, wherein said communication interface is provided by at least one of: a wired interface, a wireless interface.
B7. The system of B1, wherein said transmitting is performed asynchronously with respect to said storing.
B8. The system of B1, wherein said at least a portion of data outputted by said one or more sensor unit is digitally signed before said storing and said transmitting.
B9. The system of B1, wherein said transmitting is performed responsive to one of: a request from an external computer, a change in at least one sensor unit reading, expiration of a pre-defined timeout, and completion of a reading cycle of said one or more sensor unit.
B10. The system of B1, wherein said storing is performed responsive to one of: a change in at least one sensor reading, expiration of a pre-defined timeout, and completion of a reading cycle of said one or more sensor unit.
C1. A system comprising:

a injection molding assembly mold having a stationary section and a moveable section, said stationary section having a channel assembly and one or more nozzle, said mold further comprising one or more sensor unit, each sensor unit including one or more sensor;

a processing circuit comprising one or more processor, a communication interface, and a memory including a volatile memory and a non-volatile memory;

wherein said processing circuit is mounted to one of: said stationary section and said moveable section in a manner that said processing circuit is supported in a fixed position relative to one of: said stationary section and said moveable section;

wherein said system is configured to perform storing in said non-volatile memory at least a first portion of data outputted by said one or more sensor unit, transmitting via said communication interface at least a second portion of data outputted by said one or more sensor unit, purging from said non-volatile memory at least a third portion of data outputted by said one or more sensor unit;

wherein said first portion of data includes said third portion of data.
C2. The system of C1, wherein said processing circuit comprises at least one processor configured to execute a heating control software program to control at least one of: a power supplied to one or more heating element, a current supplied to one or more heating element.
C3. The system of C1, wherein said processing circuit comprises one or more sensor interface configured to input one or more sensor signals.
C4. The system of C1, wherein said processing circuit comprises one or more power switching module interface configured to be coupled to one or more switching module; and

wherein said one or more switching module is configured to control a controlled device.
C5. The system of C1, wherein said processing circuit is configured to communicate with at least one controller via said communication interface; and

wherein said at least one controller is configured to execute a heating control software program to control at least one of: a power supplied to one or more heating element, a current supplied to one or more heating element.
C6. The system of C1, wherein said communication interface is provided by at least one of: a wired interface, a wireless interface.
C7. The system of C1, wherein said transmitting is performed asynchronously with respect to said storing.
C8. The system of C1, wherein said at least a portion of data outputted by said one or more sensor unit is digitally signed before said storing and said transmitting.
C9. The system of C1, wherein said transmitting is performed responsive to one of: a request from an external computer, a change in at least one sensor unit reading, expiration of a pre-defined timeout, and completion of a reading cycle of said one or more sensor unit.
C10. The system of C1, wherein said storing is performed responsive to one of: a change in at least one sensor reading, expiration of a pre-defined timeout, and completion of a reading cycle of said one or more sensor unit.
D1. A system comprising:

a injection molding assembly mold having a stationary section and a moveable section, said stationary section having a channel assembly and one or more nozzle, said mold further comprising one or more sensor unit, each sensor unit including one or more sensor;

a processing circuit comprising one or more processor, a communication interface, and a memory including a volatile memory and a non-volatile memory;

wherein said processing circuit is mounted to one of: said stationary section and said moveable section in a manner that said processing circuit is supported in a fixed position relative to one of: said stationary section and said moveable section;

wherein said system is configured to perform at least one of: storing in said non-volatile memory at least a portion of data outputted by said one or more sensor unit, transmitting via said communication interface at least a portion of data outputted by said one or more sensor unit; and

wherein said at least a portion of data outputted by said one or more sensor unit is digitally signed before said storing and said transmitting.
D2. The system of D1, wherein said processing circuit comprises at least one processor configured to execute a heating control software program to control at least one of: a power supplied to one or more heating element, a current supplied to one or more heating element.
D3. The system of D1, wherein said processing circuit comprises one or more sensor interface configured to input one or more sensor signals.
D4. The system of D1, wherein said processing circuit comprises one or more power switching module interface configured to be coupled to one or more switching module; and

wherein said one or more switching module is configured to control a controlled device.
D5. The system of D1, wherein said processing circuit is configured to communicate with at least one controller via said communication interface; and

wherein said at least one controller is configured to execute a heating control software program to control at least one of: a power supplied to one or more heating element, a current supplied to one or more heating element.
D6. The system of D1, wherein said communication interface is provided by at least one of: a wired interface, a wireless interface.
D7. The system of D1, wherein said transmitting is performed asynchronously with respect to said storing.
D8. The system of D1, wherein said at least a portion of data outputted by said one or more sensor unit is digitally signed before said storing and said transmitting.
D9. The system of D1, wherein said transmitting is performed responsive to one of: a request from an external computer, a change in at least one sensor reading, expiration of a pre-defined timeout, and completion of a reading cycle of said one or more sensor unit.
D10. The system of D1, wherein said storing is performed responsive to one of: a change in at least one sensor reading, expiration of a pre-defined timeout, and completion of a reading cycle of said one or more sensor unit.
E1. A system comprising:

a injection molding assembly mold having a stationary section and a moveable section, said stationary section having a channel assembly and one or more nozzle, said mold further comprising one or more sensor unit, each sensor unit including one or more sensor;

a processing circuit comprising one or more processor, a communication interface, and a memory including a volatile memory and a non-volatile memory;

wherein said processing circuit is mounted to one of: said stationary section and said moveable section in a manner that said processing circuit is supported in a fixed position relative to one of: said stationary section and said moveable section;

a local database residing in said non-volatile memory;

wherein said system is configured to store in said local database at least a portion of data outputted by said one or more sensor unit;

wherein said local database is provided by at least one of: at least one flat file; a relational database, a hierarchical database.
E2. The system of E1, wherein said processing circuit comprises at least one processor configured to execute a heating control software program to control at least one of: a power supplied to one or more heating element, a current supplied to one or more heating element.
E3. The system of E1, wherein said processing circuit comprises one or more sensor interface configured to input one or more sensor signals.
E4. The system of E1, wherein said processing circuit comprises one or more power switching module interface configured to be coupled to one or more switching module; and

wherein said one or more switching module is configured to control a controlled device.
E5. The system of E1, wherein said processing circuit is configured to communicate with at least one controller via at least one communication interface; and

wherein said at least one controller is configured to execute a heating control software program to control at least one of: a power supplied to one or more heating element, a current supplied to one or more heating element.
E6. The system of E1 further comprising an HTTP server;

wherein said HTTP server is configured to receive HTTP requests containing requests for data from said local database.
E7. The system of E1 further comprising a communication interface;

wherein said system is configured to transmit via said communication interface at least a second portion of data outputted by said one or more sensor unit.
E8. The system of E1 further comprising a communication interface;

wherein said system is configured to transmit via said communication interface at least a second portion of data outputted by said one or more sensor unit responsive to a request from an external computer according to a request-response protocol.
E9. The system of E1 further comprising a communication interface;

wherein said system is configured to transmit via said communication interface at least a second portion of data outputted by said one or more sensor unit responsive to a request from an external computer according to a request-response protocol; and

wherein said request-response protocol is provided by one of: HTTP protocol, FTP protocol.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or more than the mentioned certain number of elements. Also, while a number of particular embodiments have been described, it will be understood that features and aspects that have been described with reference to each particular embodiment can be used with each remaining particularly described embodiment.

We claim:

1. A system comprising:
a injection molding assembly mold having a stationary section and a moveable section, said stationary section having a channel assembly and one or more nozzle, said mold further comprising one or more sensor unit, each sensor unit including one or more sensor;
a processing circuit comprising one or more processor and a communication interface;
wherein said processing circuit is mounted to one of: said stationary section and said moveable section in a manner that said processing circuit is supported in a fixed position relative to one of: said stationary section and said moveable section;
wherein said system is configured to transmit via said communication interface at least a portion of data outputted by said one or more sensor unit responsive to one of: a request from an external computer, a change in at least one sensor reading, expiration of a pre-defined timeout, and completion of a reading cycle of said one or more sensor unit.

2. The system of claim 1, wherein said processing circuit comprises at least one processor configured to execute a heating control software program to control at least one of:
a power supplied to one or more heating element, a current supplied to one or more heating element.

3. The system of claim 1, wherein said processing circuit comprises one or more sensor interface configured to input one or more sensor signals.

4. The system of claim 1, wherein said processing circuit comprises one or more power switching module interface configured to be coupled to one or more switching module; and
wherein said one or more switching module is configured to control a controlled device.

5. The system of claim 1, wherein said processing circuit is configured to communicate with at least one controller via said communication interface; and
wherein said at least one controller is configured to execute a heating control software program to control at least one of: a power supplied to one or more heating element, a current supplied to one or more heating element.

6. The system of claim 1, wherein said communication interface is provided by at least one of: a wired interface, a wireless interface.

7. The system of claim 1, wherein said communication interface is configured to be electrically coupled to a dumb terminal via a cable

8. The system of claim 1, wherein said at least a portion of data outputted by said one or more sensor unit is digitally signed before said transmitting.

9. The system of claim 1, wherein said processing circuit further comprises a memory including a volatile memory and a non-volatile memory;
wherein said system is further configured to store in said non-volatile memory at least a second portion of data outputted by said one or more sensor unit.

10. A system comprising:
a injection molding assembly mold having a stationary section and a moveable section, said stationary section having a channel assembly and one or more nozzle, said mold further comprising one or more sensor unit, each sensor unit including one or more sensor;
a processing circuit comprising one or more processor, a communication interface, and a memory including a volatile memory and a non-volatile memory;
wherein said processing circuit is mounted to one of: said stationary section and said moveable section in a manner that said processing circuit is supported in a fixed position relative to one of: said stationary section and said moveable section;
wherein said system is configured to perform storing in said non-volatile memory at least a first portion of data outputted by said one or more sensor unit and transmitting via said communication interface at least a second portion of data outputted by said one or more sensor unit; and
wherein said second portion of data includes said first portion of data.

11. The system of claim 10, wherein said processing circuit comprises at least one processor configured to execute a heating control software program to control at least one of: a power supplied to one or more heating element, a current supplied to one or more heating element.

12. The system of claim 10, wherein said processing circuit comprises one or more sensor interface configured to input one or more sensor signals.

13. The system of claim 10, wherein said processing circuit comprises one or more power switching module interface configured to be coupled to one or more switching module; and
wherein said one or more switching module is configured to control a controlled device.

14. The system of claim 10, wherein said processing circuit is configured to communicate with at least one controller via said communication interface; and
wherein said at least one controller is configured to execute a heating control software program to control at least one of: a power supplied to one or more heating element, a current supplied to one or more heating element.

15. The system of claim 10, wherein said communication interface is provided by at least one of: a wired interface, a wireless interface.

16. The system of claim 10, wherein said transmitting is performed asynchronously with respect to said storing.

17. The system of claim 10, wherein said at least a portion of data outputted by said one or more sensor unit is digitally signed before said storing and said transmitting.

18. The system of claim 10, wherein said transmitting is performed responsive to one of: a request from an external computer, a change in at least one sensor unit reading, expiration of a pre-defined timeout, and completion of a reading cycle of said one or more sensor unit.

19. The system of claim 10, wherein said storing is performed responsive to one of: a change in at least one sensor reading, expiration of a pre-defined timeout, and completion of a reading cycle of said one or more sensor unit.

20. A system comprising:
a injection molding assembly mold having a stationary section and a moveable section, said stationary section having a channel assembly and one or more nozzle, said mold further comprising one or more sensor unit, each sensor unit including one or more sensor;
a processing circuit comprising one or more processor, a communication interface, and a memory including a volatile memory and a non-volatile memory;
wherein said processing circuit is mounted to one of: said stationary section and said moveable section in a manner that said processing circuit is supported in a fixed position relative to one of: said stationary section and said moveable section;
wherein said system is configured to perform storing in said non-volatile memory at least a first portion of data outputted by said one or more sensor unit, transmitting via said communication interface at least a second portion of data outputted by said one or more sensor unit, purging from said non-volatile memory at least a third portion of data outputted by said one or more sensor unit;
wherein said first portion of data includes said third portion of data.

21. The system of claim 20, wherein said processing circuit comprises at least one processor configured to execute a heating control software program to control at least one of: a power supplied to one or more heating element, a current supplied to one or more heating element.

22. The system of claim 20, wherein said processing circuit comprises one or more sensor interface configured to input one or more sensor signals.

23. The system of claim 20, wherein said processing circuit comprises one or more power switching module interface configured to be coupled to one or more switching module; and
wherein said one or more switching module is configured to control a controlled device.

24. The system of claim 20, wherein said processing circuit is configured to communicate with at least one controller via said communication interface; and
wherein said at least one controller is configured to execute a heating control software program to control at least one of: a power supplied to one or more heating element, a current supplied to one or more heating element.

25. The system of claim 20, wherein said communication interface is provided by at least one of: a wired interface, a wireless interface.

26. The system of claim 20, wherein said transmitting is performed asynchronously with respect to said storing.

27. The system of claim 20, wherein said at least a portion of data outputted by said one or more sensor unit is digitally signed before said storing and said transmitting.

28. The system of claim 20, wherein said transmitting is performed responsive to one of: a request from an external computer, a change in at least one sensor unit reading, expiration of a pre-defined timeout, and completion of a reading cycle of said one or more sensor unit.

29. The system of claim 20, wherein said storing is performed responsive to one of: a change in at least one sensor reading, expiration of a pre-defined timeout, and completion of a reading cycle of said one or more sensor unit.

30. A system comprising:
a injection molding assembly mold having a stationary section and a moveable section, said stationary section having a channel assembly and one or more nozzle, said mold further comprising one or more sensor unit, each sensor unit including one or more sensor;
a processing circuit comprising one or more processor, a communication interface, and a memory including a volatile memory and a non-volatile memory;
wherein said processing circuit is mounted to one of: said stationary section and said moveable section in a manner that said processing circuit is supported in a fixed position relative to one of: said stationary section and said moveable section;
wherein said system is configured to perform at least one of: storing in said non-volatile memory at least a portion of data outputted by said one or more sensor unit, transmitting via said communication interface at least a portion of data outputted by said one or more sensor unit; and
wherein said at least a portion of data outputted by said one or more sensor unit is digitally signed before said storing and said transmitting.

31. The system of claim 30, wherein said processing circuit comprises at least one processor configured to execute a heating control software program to control at least one of: a power supplied to one or more heating element, a current supplied to one or more heating element.

32. The system of claim 30, wherein said processing circuit comprises one or more sensor interface configured to input one or more sensor signals.

33. The system of claim 30, wherein said processing circuit comprises one or more power switching module interface configured to be coupled to one or more switching module; and
wherein said one or more switching module is configured to control a controlled device.

34. The system of claim 30, wherein said processing circuit is configured to communicate with at least one controller via said communication interface; and
wherein said at least one controller is configured to execute a heating control software program to control at least one of: a power supplied to one or more heating element, a current supplied to one or more heating element.

35. The system of claim 30, wherein said communication interface is provided by at least one of: a wired interface, a wireless interface.

36. The system of claim 30, wherein said transmitting is performed asynchronously with respect to said storing.

37. The system of claim 30, wherein said at least a portion of data outputted by said one or more sensor unit is digitally signed before said storing and said transmitting.

38. The system of claim 30, wherein said transmitting is performed responsive to one of: a request from an external computer, a change in at least one sensor reading, expiration of a pre-defined timeout, and completion of a reading cycle of said one or more sensor unit.

39. The system of claim 30, wherein said storing is performed responsive to one of: a change in at least one sensor reading, expiration of a pre-defined timeout, and completion of a reading cycle of said one or more sensor unit.

40. A system comprising:
a injection molding assembly mold having a stationary section and a moveable section, said stationary section having a channel assembly and one or more nozzle, said mold further comprising one or more sensor unit, each sensor unit including one or more sensor;
a processing circuit comprising one or more processor, a communication interface, and a memory including a volatile memory and a non-volatile memory;
wherein said processing circuit is mounted to one of: said stationary section and said moveable section in a manner that said processing circuit is supported in a fixed position relative to one of: said stationary section and said moveable section;
a local database residing in said non-volatile memory;
wherein said system is configured to store in said local database at least a portion of data outputted by said one or more sensor unit;
wherein said local database is provided by at least one of: at least one flat file; a relational database, a hierarchical database.

41. The system of claim 40, wherein said processing circuit comprises at least one processor configured to execute a heating control software program to control at least one of: a power supplied to one or more heating element, a current supplied to one or more heating element.

42. The system of claim 40, wherein said processing circuit comprises one or more sensor interface configured to input one or more sensor signals.

43. The system of claim 40, wherein said processing circuit comprises one or more power switching module interface configured to be coupled to one or more switching module; and
wherein said one or more switching module is configured to control a controlled device.

44. The system of claim 40, wherein said processing circuit is configured to communicate with at least one controller via at least one communication interface; and
wherein said at least one controller is configured to execute a heating control software program to control at least one of: a power supplied to one or more heating element, a current supplied to one or more heating element.

45. The system of claim 40, further comprising an HTTP server;
wherein said HTTP server is configured to receive HTTP requests containing requests for data from said local database.

46. The system of claim 40, further comprising a communication interface;
wherein said system is configured to transmit via said communication interface at least a second portion of data outputted by said one or more sensor unit.

47. The system of claim 40, further comprising a communication interface;
wherein said system is configured to transmit via said communication interface at least a second portion of data outputted by said one or more sensor unit responsive to a request from an external computer according to a request-response protocol.

48. The system of claim 40, further comprising a communication interface;
wherein said system is configured to transmit via said communication interface at least a second portion of data outputted by said one or more sensor unit responsive to a request from an external computer according to a request-response protocol; and
wherein said request-response protocol is provided by one of: HTTP protocol, FTP protocol.
